(19) United States
(12) Patent Application Publication
(10) Pub. No.: US 2007/0233535 A1
(43) Pub. Date: Oct. 4, 2007

(54) System and method for integrating operation of business software managing execution of business process based on time

(76) Inventor: Giloong Kim, Seoul (KR)

Correspondence Address: EDWARDS ANGELL PALMER & DODGE LLP, P.O. BOX 55874, BOSTON, MA, 02205, US

(21) Appl. No.: 11/732,460

(22) Filed: Apr. 2, 2007

(30) Foreign Application Priority Data
Mar. 31, 2006 (KR) 10-2006-0029417

(51) Int. Cl. G06F 17/50

(52) U.S. Cl. 705/7

(57) ABSTRACT

The present invention relates to a system and a method for integrating operation of business software to manage a business process by dividing businesses into unit works (tasks) and managing the tasks based on time. The system includes: an organization information managing unit for inputting and managing at least one of client information, company information, department information and user information; a business scheduling engine for arranging a schedule for carrying out tasks of users and arranging scheduling information including work transaction information with the users in charge of the tasks; a work transaction state managing unit for performing real-time management of work transaction states of the arranged scheduling information; and a business portal unit for generating the scheduling information and the work transaction states in a diary interface composed of visual information and work information, providing the scheduling information and the work transaction states to the users, and providing at least one work-related additional function selected from the group including daily, weekly, and monthly personal schedule management, news search and e-mail transmission.

### CROSS-REFERENCE TO RELATED APPLICATION

The present application claims, under 35 U.S.C. §119, the benefit of Korean Patent Application No. 10-2006-0029417, filed Mar. 31, 2006, the entire contents of which are hereby incorporated by reference.

### BACKGROUND OF THE INVENTION

1. Field of the Invention

The present invention relates to a system and a method for integrating operation of business software that manages a business process based on time. More specifically, the present invention relates to a system and a method for integrating operation of business software, which can execute a business process inside and outside a company based on time by automatically informing a user-in-charge of a first unit work (task), automatically driving and executing a linked program when the user selects the first unit work, and automatically informing a user-in-charge of a second unit work when the first unit work is completed.

2. Background Art

A current trend is that a business process is performed by executing business projects using hardware resources and software resources integrated by IT technology. Generally, a business project is divided into a plurality of tasks and each task is assigned to at least one director.

In such cases, a user interface of a business software typically employs a menu-driven method. The menu-driven method provides a user with a menu list and then operates a function corresponding to the menu selected by the user. Thus, the user does not need to know an instruction code when using the menu-driven method. For this reason, the menu-driven method has been widely used.

However, as a business process tends to have a complicated structure and expanded functions in theses days, conventional operating systems and methods based on the menu-driven method have problems as listed in Table 1 below.

TABLE 1

| Problems | Descriptions |
|---|---|
| Problem 1 | Although the function and structure of current menu-driven systems are |
| | systemic and reasonable from the viewpoint of system developers, they are |
| | too much complicated to understand from the viewpoint of users who |
| | should learn and use the systems on the job site. |
| Problem 2 | Since works of various fields are developed with different subjects and at |
| | different points of time in these days, they have different design spirits, |
| | functions and structures and are thus separately transacted by different |
| | systems. Although such systems all are operated using a menu, they are |
| | different in terms of construction methods and internal structures, which |
| | causes a serious problem. |
| Problem 3 | Integration systems widely used in these days generally include a number of |
| | subordinate functions (menus) embedded in a highly systemic structure, and |
| | it is thus difficult for users to locate a desired function. |
| Problem 4 | Although business processes are all computerized, users of the menu-driven |
| | method should bristle up their nerve lest they should forget the business |
| | type, transacting point of time, and transacting method of their works. As |
| | a result, the users consume their energy much more in searching for their |
| | works than in transacting their works. Thus, even though the business |
| | processes are all computerized, the menu-driven method does not show |
| | improved effect or speed of the business process. |

As described above, with the prior art systems and methods, a user should first know about a program to perform his/her task (unit work) each process. And, he/she should know about a complicated menu structure of the program so as to be able to select a specific menu. The overall process efficiency thus depends on work recognizing and transacting ability of the user.

Even e-Business Suite, a currently and widely used business integrating system, has such problems. The system includes an ERP (Enterprise Resource Planning). The ERP has a four- or five-layered tree structure composed of several hundreds to several thousands of menus. The system includes ten or more individual subordinate systems therein in addition to the ERP. User interfaces based on such multi-layer-structure menu-driven interface method requires users to make numerous trials and errors and spend unnecessary time and efforts. In other words, the menu-driven method which is intended for promoting the convenience of users rather reduces the overall work efficiency.

There is thus a need for a user-centered software which enables users to easily and conveniently do their works (tasks) and help users save their time and efforts to do their tasks. There is also a need for a user-centered software which has a new interface mechanism that enables users to effectively work based on time.

### SUMMARY OF THE INVENTION

The present invention is designed to solve the problems of conventional interface of business software and operating method based thereupon, and therefore it is an object of the present invention to implement a TDB (Time Driven Business) technique, i.e. a user interface mechanism individualized based on time, to effectively utilize resource of time and dramatically strengthen the competitiveness of an enterprise.

It is another object of the present invention to sort and arrange all business types of works of users on the basis of systemic standards (for example, works are sorted and arranged intelligently and dynamically according to acceptance order, importance, priority, business type and so on) and display the works in a single interface method such as a diary.

It is still another object of the present invention to realize a true RTE (Real-Time Enterprise), in which, once users simply select their works on a diary, software required to transact the works is automatically connected and executed, and all of work transacting functions to be transacted instantly are performed.

In order to achieve the above-mentioned objects, in one aspect, the present invention provides a system for integrating operation of business software to manage a business process by dividing a business project into unit works (tasks) and managing the tasks based on time. In a preferred embodiment, the system comprises: an organization information managing unit for inputting and managing at least one of client information, company information, department information and user information; a business scheduling engine for arranging a schedule for carrying out tasks of users and arranging scheduling information including work transaction information with the users in charge of the tasks; a work transaction state managing unit for performing real-time management of work transaction states of the arranged scheduling information; and a business portal unit for generating the scheduling information and the work transaction states in a diary interface composed of visual information and work information, providing the scheduling information and the work transaction states to the users, and providing at least one work-related additional function selected from the group including daily, weekly, and monthly personal schedule management, news search and e-mail transmission

Preferably, the business scheduling engine generates the scheduling information through at least one of the following functions. A first function is to determine a work occurrence source and motive type of the tasks by sorting the tasks into “order” for the tasks generated by the workflow engine when a time for a particular user to transact the task comes, “point of time” for the tasks occurring when a time set by the workflow engine or the schedule managing engine shows a predefined time comes, “request” for the tasks generated by the schedule managing engine or the e-mail engine in accordance with a customer's orders or user's instructions, and “awareness” for the tasks registered in the schedule managing engine in accordance with judgment or recognition of the users.

A second function is to determine a work transaction speed by sorting the tasks into “regular” for the tasks that have no time limit or have to be completed by a specific due date and “urgent” for the tasks that have to be transacted instantly with the highest priority as designated by the schedule managing engine or the e-mail engine.

A third function is to determine a work transaction time of the tasks by sorting the tasks into “instant” for the tasks that should be transacted as soon as possible, “time limit” for the tasks that have to be transacted by a designated time limit and “period” for the tasks that have to be transacted repetitively during a predetermined period.

A fourth function is to determine a work security grade of the tasks by sorting the tasks into “public” for the tasks that can be transacted by any person and “restricted” for the tasks that have to be transacted only by a designated person.

A fifth function is to determine a work transaction range by sorting the tasks into “an individual in charge” for the tasks that are to be transacted by a user-in-charge, “an individual in duty” for the tasks that are to be transacted by a user having a specific duty, “a selective group” for the tasks that are to be transacted by any member of a selected group, and “a cooperative group” for the tasks that are to be transacted simultaneously or sequentially by members of a selected group.

In another preferred embodiment, the business scheduling engine generates the scheduling information from the tasks received from at least one engine selected from the group including a work flow engine, a schedule managing engine and an e-mail engine. The workflow engine manages the tasks by a built-in workflow of a business process management (BPM) solution in the system. The schedule managing engine manages the tasks by schedule arrangement and management function included in each module of the business software and scheduler function set manually by the users. The e-mail engine manages the tasks received through e-mails or messengers.

In this embodiment, the business scheduling engine also generates the scheduling information through at least one of the above-described functions.

In still another preferred embodiment, the business portal unit provides the users with an interface display. The interface display may be generated by at least one of a business worklist display unit, a personal schedule display unit, a work transaction state display unit, a workflow display unit, and a contents display unit. The business worklist display unit sorts the tasks received from the business scheduling engine in terms of a work acceptance order, a work transaction speed, a work transaction time, a work security grade and a work transaction range from the viewpoint of the users, regardless of work occurrence source and motive type, and provides the sorted tasks to the users.

The personal schedule display unit arranges in order of time all schedules of the users including personal schedule information manually inputted by the users together with the scheduling information, integrates the schedules in a diary including daily, weekly and monthly types, and provides a search service of the schedules.

The work transaction state display unit sorts information of the work transaction state of pending tasks of the users, which are received from the work transaction state managing unit, into completion, pendency, cancel, delay and reservation, and provides the sorted information.

The workflow display unit registers (receives) detailed functions of workflow, documents and programs frequently used by the users and immediately connects to and transacts a task selected by the users.

The contents display unit connects to web sites which provide news or other contents, and real-time updating various types of external information.

Preferably, the business worklist display unit displays the tasks designated to the users-in-charge in a diary structure, and when an item of an individual task is selected, automatically executes an application program designated to the task.

Suitably, the schedule managing engine performs several functions. First, it connects a specific data input box of the business software to a scheduling management item by the users in a drag-and-drop manner. Second, when a proper data is inputted to the data input box connected to the scheduling management item in the process of work transaction, the schedule managing engine recognizes task information including at least one of transaction date, transaction time, available period, title, subject, business type, preparations, partner, and director of a management item corresponding to the input data, and stores the work information in a schedule managing database. Third, the schedule managing engine informs the users-in-charge of the task or automatically executes linked application programs and documents according to the task information stored in the database.

In another aspect, the present invention provides a method for integrating operation of business software to manage a business process by dividing a project into tasks and managing the tasks based on time. In a preferred embodiment, the method comprises the steps of: identifying by a business scheduling engine at least one of a department, position and duty of users in charge of tasks; identifying by a workflow engine of a business process management (BPM) solution the tasks automatically designated to each user; identifying the tasks reserved to a corresponding user through a schedule managing engine that manages a schedule arrangement and management function included in each module of business software and a scheduler function through which the user sets the tasks and linked programs; identifying demands or requests of external customers, and instructions of members of other organizations received through an e-mail engine; determining a work occurrence source and motive type of the tasks identified in at least one of the above steps with reference to organization information of the users identified in the step of identifying by the business scheduling engine; determining a work transaction speed of the users-in-charge according to whether the tasks are urgent or not; determining a work transaction time required for the users-in-charge according to when the tasks should be transacted; determining a work security grade of the users-in-charge according to a security grade of the tasks; determining a work execution range of the users-in-charge; and sorting a plurality of items by at least one of the work occurrence source and motive type, work transaction speed, work transaction time, work security grade, and work execution range in a diary form and transmitting the items to a business portal unit.

Preferably, the work occurrence source and motive type of the tasks is determined by sorting the tasks into at least one category selected from the group including: “order” for the tasks generated by the workflow engine when a time for a particular user to transact the task comes; “point of time” for the tasks occurring when a time set by the workflow engine or the schedule managing engine shows a predefined time comes; “request” for the tasks generated by the schedule managing engine or the e-mail engine in accordance with customer's orders or user's instructions; and “awareness” for the tasks registered in the schedule managing engine in accordance with judgment or recognition of the users.

Also preferably, the work transaction speed is determined by sorting the tasks into at least one category selected from the group including: “regular” for ordinary tasks which are not urgent; and “urgent” for the tasks that have to be transacted instantly with the highest priority as designated by the schedule managing engine or the e-mail engine.

Suitably, the work transaction time is determined by sorting the tasks into at least one category including: “instant” for the tasks that should be transacted as soon as possible; “time limit” for the tasks that have to be transacted by a designated time limit; and “period” for the tasks that have to be transacted repetitively during a predetermined period.

Also suitably, the work security grade is determined by sorting the tasks into at least one category including: “public” for the tasks that can be transacted by any person; and “restricted” for the tasks that have to be transacted only by a designated person.

Still suitably, the work transaction range is determined by sorting the tasks into at least one category including: “an individual in charge” for the tasks that are to be transacted by a user-in-charge; “an individual in duty” for the tasks that are to be transacted by a user having a specific duty; “a selective group” for the tasks that are to be transacted by any member of a selected group; and “a cooperative group” for the tasks that are to be transacted simultaneously or sequentially by members of a selected group.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a block diagram of a system for integrating operation of business software in accordance with an exemplary embodiment of the present invention.

FIG. 2 is a functional block diagram of the system for integrating operation of business software in accordance with an exemplary embodiment of the present invention.

FIG. 3 is a flowchart of a method for integrating operation of business software in accordance with an exemplary embodiment of the present invention.

FIG. 4 is a screen view illustrating a main display in accordance with an exemplary embodiment of the present invention.

FIG. 5 is a screen view illustrating a worklist display provided by a business worklist display unit in accordance with an exemplary embodiment of the present invention.

FIG. 6 is a screen view illustrating an environment setting display of the business worklist display unit in accordance with an exemplary embodiment of the present invention.

FIG. 7 is a screen view illustrating a personal schedule display provided by a personal schedule display unit in accordance with an exemplary embodiment of the present invention.

FIG. 8 is a screen view illustrating a work transaction state display provided by a work transaction state display unit in accordance with an exemplary embodiment of the present invention.

FIG. 9 is a screen view illustrating a workflow display provided by a workflow display unit in accordance with an exemplary embodiment of the present invention.

FIG. 10 is a screen view illustrating an Internet contents display provided by a contents display unit in accordance with an exemplary embodiment of the present invention.

FIG. 11 is a screen view illustrating a software automatic execution display provided by the business worklist display unit in accordance with an exemplary embodiment of the present invention.

FIG. 12 is a screen view illustrating a scheduling setting display in accordance with an exemplary embodiment of the present invention.

FIG. 13 is an example view illustrating detailed attributes of a scheduling setting display in accordance with an exemplary embodiment of the present invention.

### DESCRIPTION OF THE PREFERRED EMBODIMENTS

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

1. Systems

As discussed above, in one aspect, the present invention provides a system for integrating operation of business software to manage a business process by dividing a business project into unit works (tasks) and managing the tasks based on time.

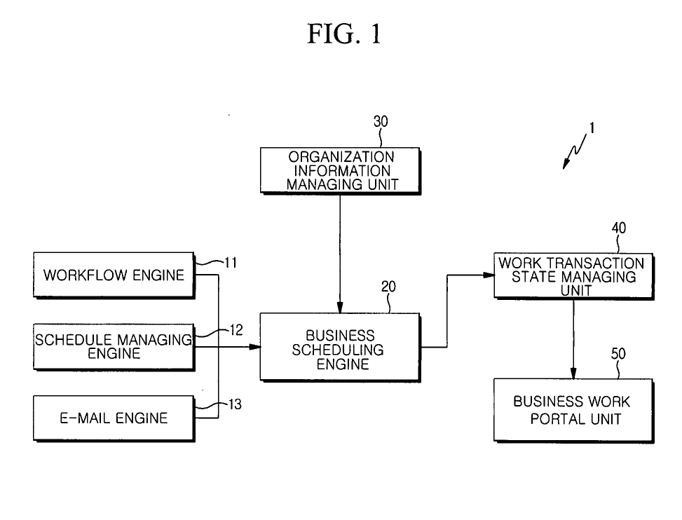

FIG. 1 is a block diagram of a system for integrating operation of business software in accordance with an exemplary embodiment of the present invention.

The system 1 in accordance with an exemplary embodiment of the present invention integrates software (SW) used as business processing means in a company, including a) a business operating system (BOS) (See U.S. Ser. No. 11/649,589 by the applicant), b) business software (for example, production, distribution, financial, personnel management programs), and c) a personal office management program (for example, Office, CAD, Photoshop and so on), and manages scheduling based on a business process according to time driven business (TDB).

For this purpose, the system 1 includes a workflow engine 11, a schedule managing engine 12, an e-mail engine 13, a business scheduling engine 20, an organization information managing unit 30, a work transaction state managing unit 40, and a business portal unit 50.

According to the present invention, after users (directors) in charge of unit works are determined and the start and end of the unit works are defined, the unit works are generated from the workflow engine 11, the schedule managing engine 12 or the e-mail engine 13, and transmitted to the business scheduling engine 20.

The workflow engine 11 manages the unit works occurred by a) the business process management (BPM) solution, such as BOS, built in the system 1.

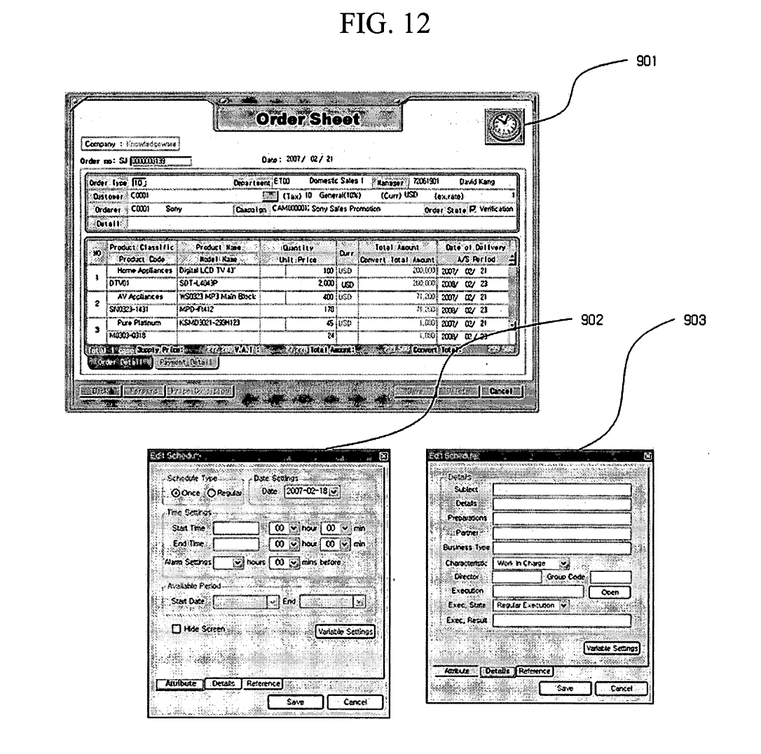

The schedule managing engine 12 manages the unit works occurred by b) a scheduling arranging and managing function included in business software and c) a scheduler function set manually by users in a personal office management program. The user drives the schedule managing engine 12, connects a specific data input box of a general business software to a scheduling management item in a drag-and-drop manner and sets work transacting information, as shown in FIG. 12 to be illustrated below. When data consistent with condition is input into the data input box connected to the scheduling management item during transacting the unit works, the schedule managing engine 12 recognizes work information (including transacting date, transacting time, available period, subject, details, business type, preparations, partner and director) of the management item corresponding to the input data and stores the work information in a schedule management database. And, the schedule managing engine 12 informs the unit works to the users in charge or automatically executes designated application programs and documents according to the work information stored in the database.

The e-mail engine 13 manages the unit works occurred by demands of customers or request or instructions of other users (for example, seniors or co-workers) through Internet e-mails or messengers.

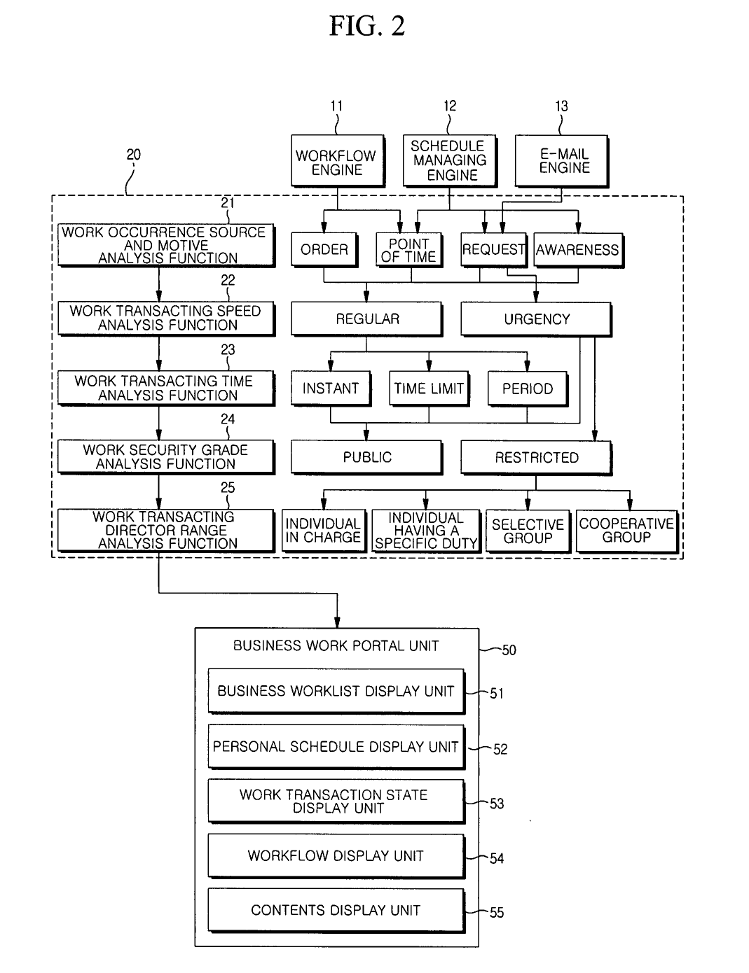

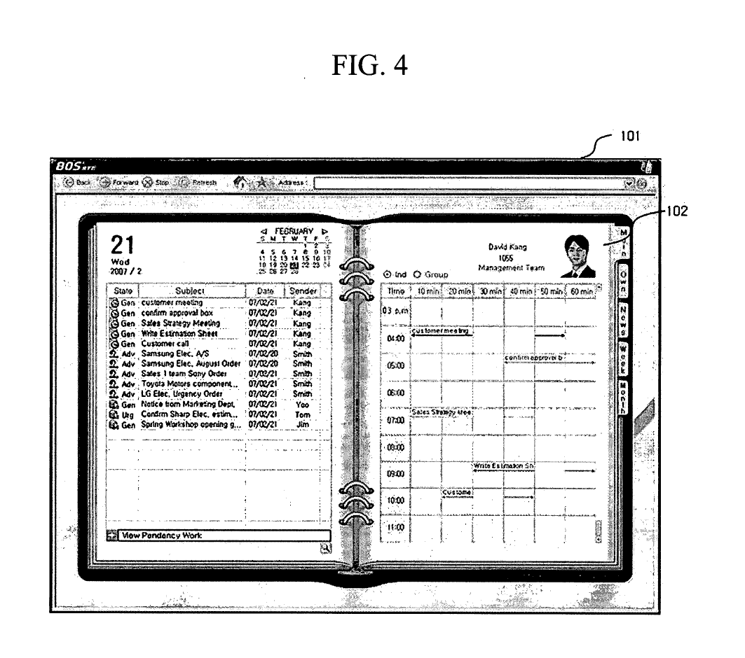

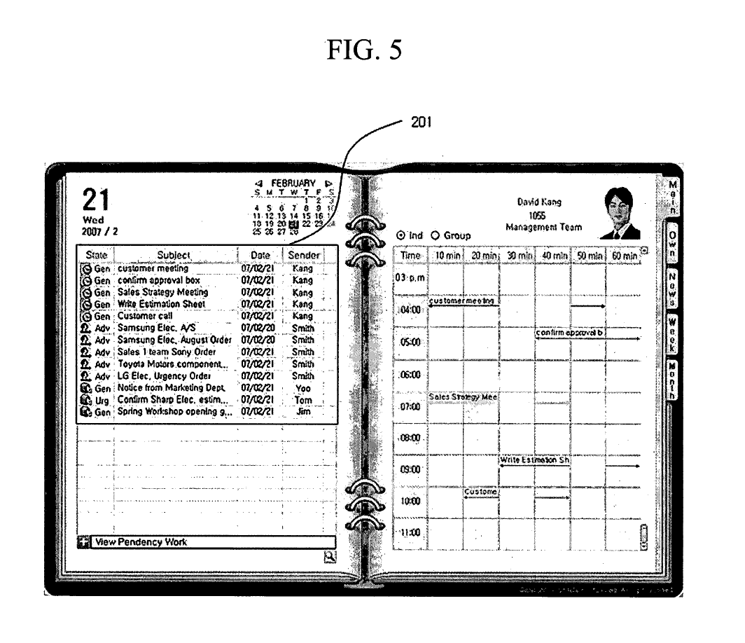

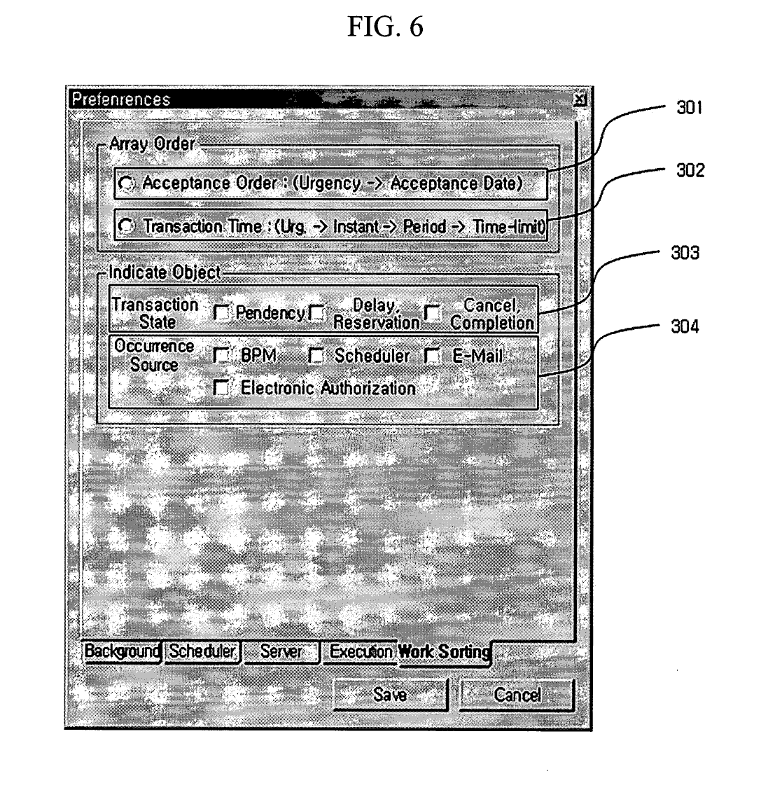

The business scheduling engine 20 receives the unit works input in the above-mentioned manners (Reference numerals 11 to 13). And, the business scheduling engine 20 analyzes a business type (See FIG. 2) according to work occurrence source, motive, work transaction speed, work transaction time, work security grade, work transaction range in real time. Here, when analyzing the work security grade and work transaction range, the business scheduling engine 20 refers to company information, department information, personal information and so on that are stored in and managed by the organization information managing unit 30. The business type of the unit works is determined, and then provided to the users-in-charge through a business worklist display unit 51 of the business portal unit 50 (See FIGS. 4 and 5). At this time, the users-in-charge may set an array order or objects displayed on the business worklist display unit 51 (See FIG. 6).

The organization information managing unit 30 manages database storing company organization information and members information constructed by a system executor so as to designate the user-in-charge of the unit works that are processed by the system 1 of the present invention.

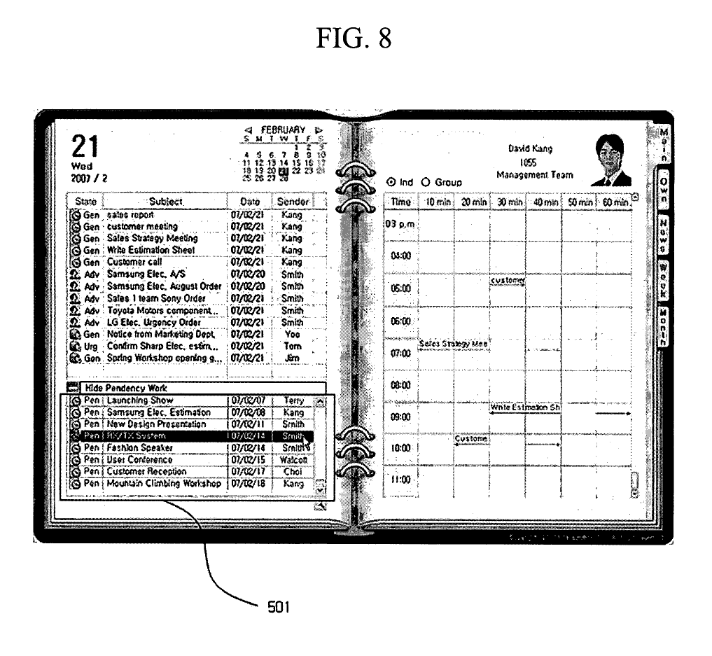

After the business scheduling engine 20 determines a business type of each work, the work transaction state managing unit 40 manages work transaction state (for example, work transaction state (for example, completed, pending, canceled, delayed, reserved and so on) while the users transact the unit works. The work transaction state managing unit 40 transmits corresponding information to the business portal unit 50 in real time and displays the information on screens of the users (See FIG. 8).

The business portal unit 50 transmits scheduling information of the system 1 to the users through a display interface (See FIGS. 4 to 12). The system 1 of the present invention may be constructed in both of stand-alone environment and network-based multi-user environment. The users connect to the system 1 and are informed of their unit works through the business portal unit 50. When the users select specific unit works with reference to the business type, SW (the above-mentioned b) and c)) corresponding to the unit works is automatically executed, and thus the users transact their unit works.

FIG. 2 is a functional block diagram of the system 1 for integrating operation of business software in accordance with an exemplary embodiment of the present invention.

The business scheduling engine 20 receives the unit works designated to the users in charge according to business analysis by the workflow engine 11, the schedule managing engine 12 and the e-mail engine 13, and determines the business type according to work occurrence source.

To determine the business type, the business scheduling engine 20 executes a work occurrence source and motive analysis function 21, a work transaction speed analysis function 22, a work transaction time analysis function 23, a work security grade analysis function 24 and a work transaction range analysis function 25.

The work occurrence source and motive analysis function 21 sorts the unit works transmitted from the workflow engine 11 into “order” type for the works of which a sequence to be transacted by specific users in charge is approaching according to work responsibility and workflow in the organization. The work occurrence source and motive analysis function 21 sorts the unit works into “point of time” type for the works of which a scheduled time is approaching according to the workflow engine 11 or the scheduling managing engine 12. The work occurrence source and motive analysis function 21 sorts the unit works transmitted from the schedule managing engine 12 into “point of time” type, “request” type for the works to be transacted by ordering of customers or instructions of seniors, and “awareness” type for the works to be transacted by judgment or recognition of the users in charge. And, finally, the work occurrence source and motive analysis function 21 sorts the unit works transmitted from the e-mail engine 13 into only “request” type for the works to be transacted by ordering of customers or instructions of seniors.

The work transaction speed analysis function 22 determines subordinate types dependent on the types determined by the work occurrence source and motive analysis function 21. Here, only the unit works determined as “request” type by the work occurrence source and motive analysis function 21 may be sorted as “urgency” type for the works to be transacted instantly with the highest priority. The unit works determined as “order” type, “point of time” type and “awareness” type including “request” type may be sorted as “regular” type for the works that are regular, not urgent.

The work transaction time analysis function 23 sorts the unit works into “instant” type for the works to be transacted as soon as unit works are assigned to users in charge, “time-limit” type for the works to be transacted by a predetermined due date, and “period” type for the works to be transacted repetitively by installments during a predetermined period. The unit works determined as “urgency” type by the work transaction speed analysis function 22 should be transacted instantly with the highest priority, and thus they are not sorted separately as the types by the transaction time analysis function 23.

The work security grade analysis function 24 sorts the unit works into “public” type for the works to be transacted by any person, and “restricted” type for the works to be transacted only by a designated person. The types of the work security grade analysis function 24 may be determined regardless of types by the other functions.

The work transaction range analysis function 25 sorts the unit works into “an individual in charge” type for the works to be transacted by a specific individual, “an individual in duty” type for the works to be transacted by an individual having a specific duty, “a selective group” for the works to be transacted by any member of a specific group, and “a cooperative group” type for the works to be transacted simultaneously or sequentially by members of a specific group. Only the unit works determined as “restricted” type by the work security grade analysis function 24 are sorted into the types of the work transaction range analysis function 25, but the unit works determined as “public” type are not sorted into the types of the work transaction range analysis function 25.

The types of the unit works are automatically determined through the above-mentioned five functions (21 to 25) and may be determined by the users in charge. The determined types are transmitted to the business portal unit 50 and arranged according to an array order and objects (See FIG. 6) of the worklist display set by each user. The types are display on a final interface display in the form of a diary, so that the users can easily understand and effectively transact the unit works.

The business portal unit 50 in accordance with an exemplary embodiment of the present invention includes a business worklist display unit 51, a personal schedule display unit 52, a work transaction state display unit 53, a workflow display unit 54, and a contents display unit 55.

The business worklist display unit 51 sorts the unit works transmitted from the business scheduling engine 20 by work acceptance order, work transaction speed, work transaction time, work security grade and work transaction range from the viewpoint of the users in charge, regardless of the work occurrence source and motive type, and provides them to the users (See FIGS. 5 and 6).

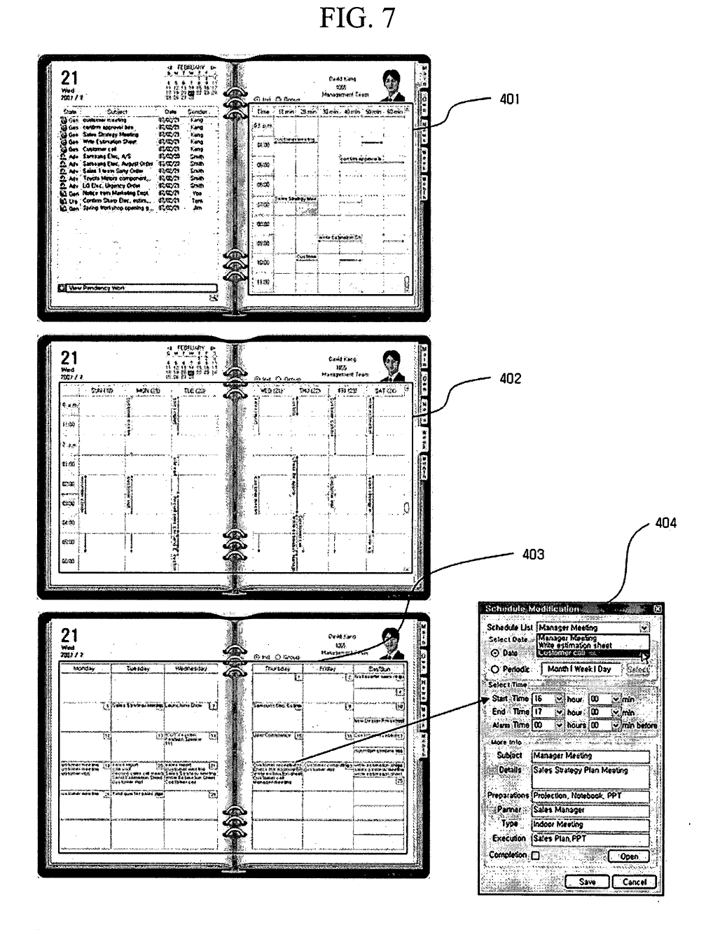

The personal schedule display unit 52 arranges personal schedule information input manually by the users in order of time, and then integrates the information daily, weekly and monthly in the form of a diary and provides a search service of the information (See FIG. 7).

The work transaction state display unit 53 sorts transaction state information of pending unit works of the users, transmitted from the work transaction state managing unit 40, into completion, pendency, cancel, delay and reservation, and provides the sorted information (See FIG. 8).

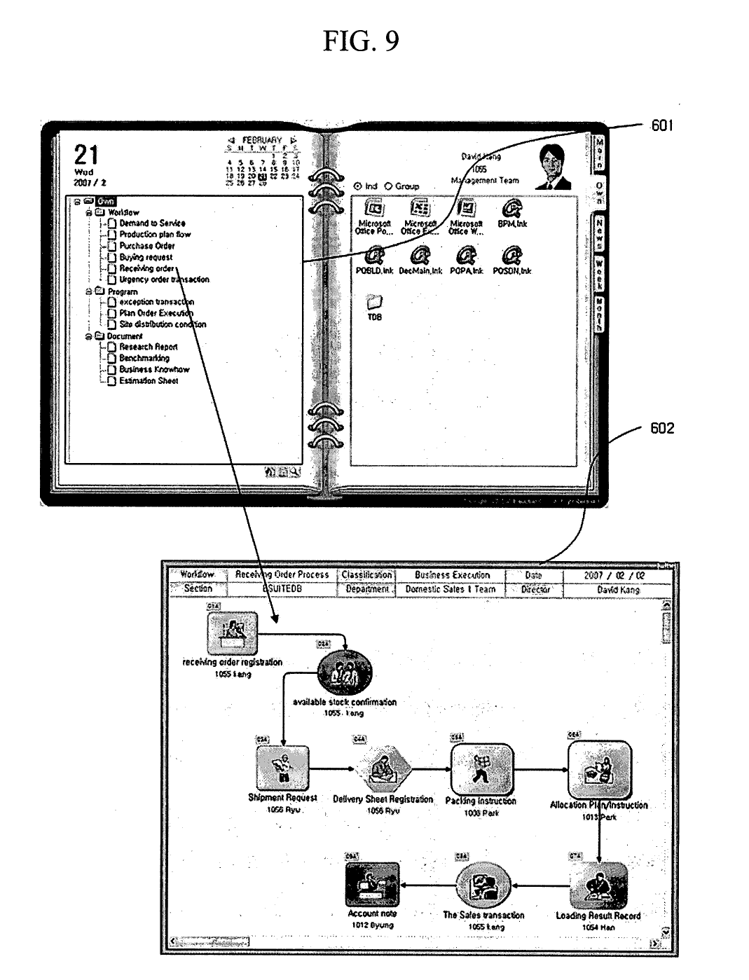

The workflow display unit 54 receives functions of workflow, documents or models used frequently by the users, and connects to and executes works corresponding to selection of the users (See FIG. 9).

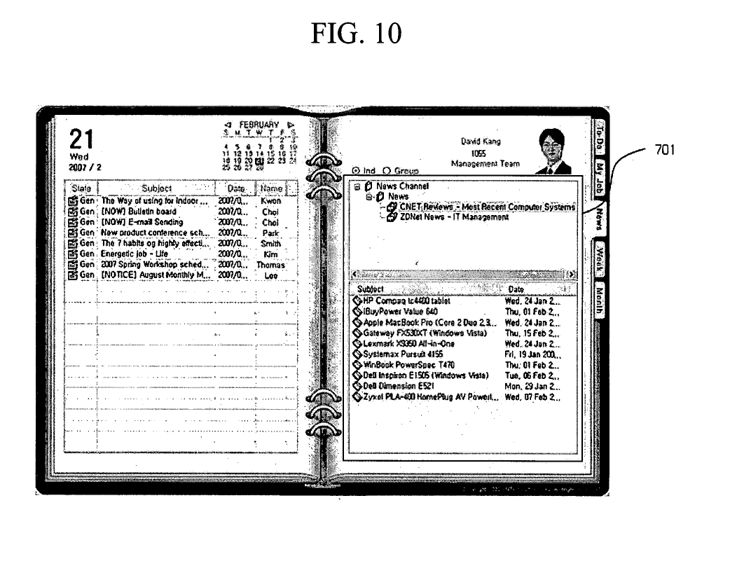

The contents display unit 55 connects to news or contents providing sites over the Internet (See FIG. 10), and automatically updates and displays the corresponding information in real time.

2. Methods

In another aspect, as discussed above, the present invention provides a method for integrating operation of business software to manage a business process by dividing a business project into unit works (tasks) and managing the tasks base on time.

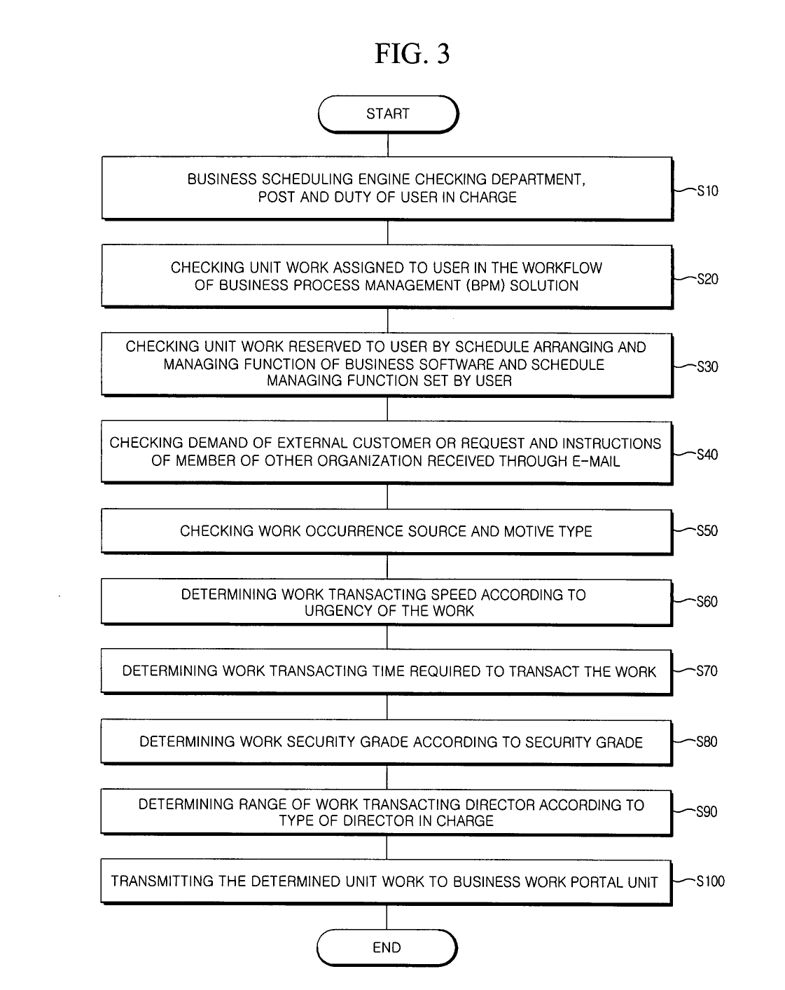

FIG. 3 is a flowchart of a method for integrating operation of business software in accordance with an exemplary embodiment of the present invention.

The method for integrating operation of business software in accordance with an exemplary embodiment of the present invention is realized by the above-mentioned system 1. The users execute programs of a computer terminal and connects to the integrating system 1 of the present invention, and then the users are provided with the scheduling information from the business portal unit 50 based on the business process according to the TDB. The users are provided with a list of the unit works in the form of a diary. The users select specific unit works, and then associated SW is automatically executed and the users starts to transact the unit works.

The business scheduling engine 20 identifies department, post and duty of the users designated as directors of unit works in real time (S10). The workflow engine 11 automatically identifies the unit works designated to each user in advance (already) on the workflow set by the BPM solution (S20). The schedule managing engine 12 identifies the unit work reserved to a corresponding user by the scheduling function included in each module of business software and schedule arrangement set manually by the users (S30). The e-mail engine 13 checks the received demands of external customers or request and instructions of members of other organization (S40).

After the unit works are identified through the steps S20 to S40, the business scheduling engine 20 determines the work occurrence source and motive type of the unit works with reference to organization information of the users identified in the step S10 (S50). In this step, as described above, the unit works are sorted into the types, such as “order” (works of which a transaction sequence is approaching according to work assignment in the organization and business process by the workflow engine), “point of time” (works of which a scheduled transaction time is approaching according to the workflow engine or the schedule managing engine), “request” (works occurred by the schedule managing engine or the e-mail engine due to ordering of customers or instructions of seniors), and “awareness” (works registered in the schedule managing engine by judgment or recognition of the users in charge).

After the work occurrence source and motive type is determined, the business scheduling engine 20 determines the work transaction speed of the users according to whether the unit works are urgent or not (S60). In this step, the unit works are sorted into the types, such as “regular” (works which are ordinary, not urgent) and “urgency” (works designated by the schedule managing engine or the e-mail engine and to be transacted instantly on the highest priority).

After the work transaction speed is determined, the business scheduling engine 20 determines the work transaction time required for the users according to the time limit of the unit work (S70). In this step, the unit works are sorted into the types, such as “instant” (works to be transacted as soon as possible), “time limit” (works to be transacted by a designated due date) and “period” (works to be transacted repetitively by installments during a predetermined period).

After the work transaction time is determined, the business scheduling engine 20 determines determining the work security grade of the users according to the security grade of the unit works (S80). In this step, the unit works are sorted into the types, such as “public” (works to be transacted by any person) and “restricted” (works to be transacted only by users of a designated grade or users in charge).

After the work security grade is determined, the business scheduling engine 20 determines the work transaction range of the users according to the types of the users in charge of the unit works (S90). In this step, the unit works are sorted into the types, such as “an individual in charge” (works to be transacted by a specific individual), “an individual in duty” (works to be transacted by an individual having a specific duty), “a selective group” (works to be transacted by any member of a specific group), and “a cooperative group” (works to be transacted simultaneously or sequentially by members of a specific group).

After the types of the unit works are determined through the steps S50 to S90, the business scheduling engine 20 generates work information in an interface of a diary form and transmits the information to the business portal unit (S 100).

3. Displays

FIG. 4 is a screen view illustrating a main display 101 in accordance with an exemplary embodiment of the present invention.

The TDB technique suggested by the present invention is applied to an interface main display 101, and the interface main display 101 is basically formed of a diary (date+contents) similar to a diary available in off-line. An interface mechanism for connecting the users to functions provided by an integrating application software for business, is not designed by a menu driven method for systemically and comprehensively providing functions of software in the form of a stratified structure, but a time driven method for analyzing works occurred from each part of software in real time according to transaction order, time and function of the users and providing it through a user interface specialized individually.

A TDB interface display 102 in the main display 101 cooperates with a corresponding business application. Elements of the TDB interface display 102 are described in detail with reference to FIG. 5 (a worklist display), FIG. 7 (a personal schedule display), FIG. 8 (a work transaction state display), FIG. 9 (a workflow model managing display), and FIG. 10 (an Internet contents providing display).

FIG. 5 is a screen view illustrating a worklist display 201 provided by the business worklist display unit 51 in accordance with an exemplary embodiment of the present invention.

The worklist display 201 is the most essential part in a user interface display of the system 1 for integrating operation of business software based on the TBD. The worklist display 201 receives information of the unit works which are analyzed by and transmitted from the business scheduling engine 20, sorts the information according to acceptance order, importance, priority, business type and so on, from the viewpoint of the users regardless of the work occurrence source or motive, and displays the information to the users. And, the worklist display 201 displays the information on the basis of an array order and objects (See FIG. 6) set directly by the users according to necessity of the users.

End-users are provided in real time with updated information about their unit works to be transacted by themselves through the worklist display 201.

FIG. 6 is a screen view illustrating an environment setting display 201 of the business worklist display unit 51 in accordance with an exemplary embodiment of the present invention.

The environment setting display 201 is an interface display for the end-users to directly set the array order or objects displayed on the worklist display 201 of FIG. 5.

The environment setting display 201 is for setting to display the array order of the unit works according to the work acceptance order 301 such that “Urgency” type is of the highest priority and the others are arranged in order of acceptance date, or the environment setting display is for setting to display the array order of the unit works according to the transaction time 302 such that “Urgency” type is of the highest priority and the others are arranged in order of “Instant”, “Period”, and “Time limit” types.

And, the environment setting display is for determining to display the unit works in the work transaction state type, such as “Pendency”, “Delay”, “Reservation”, “Completion” and “Cancel” according to the work transaction state 303 of outstanding works.

Also, the environment setting display is for determining to display the unit works in the work occurrence source type, such as works occurred from the workflow engine 11 of the BPM solution, works occurred from the schedule managing engine 12 through the scheduler set directly by the user or by the schedule arranging and managing function included in business application, works occurred through e-mails or messengers from the e-mail engine 13, and works occurred from the workflow engine 11 by electronic authorization solution according to the work occurrence source 304.

FIG. 7 is a screen view illustrating a personal schedule display provided by the personal schedule display unit 52 in accordance with an exemplary embodiment of the present invention.

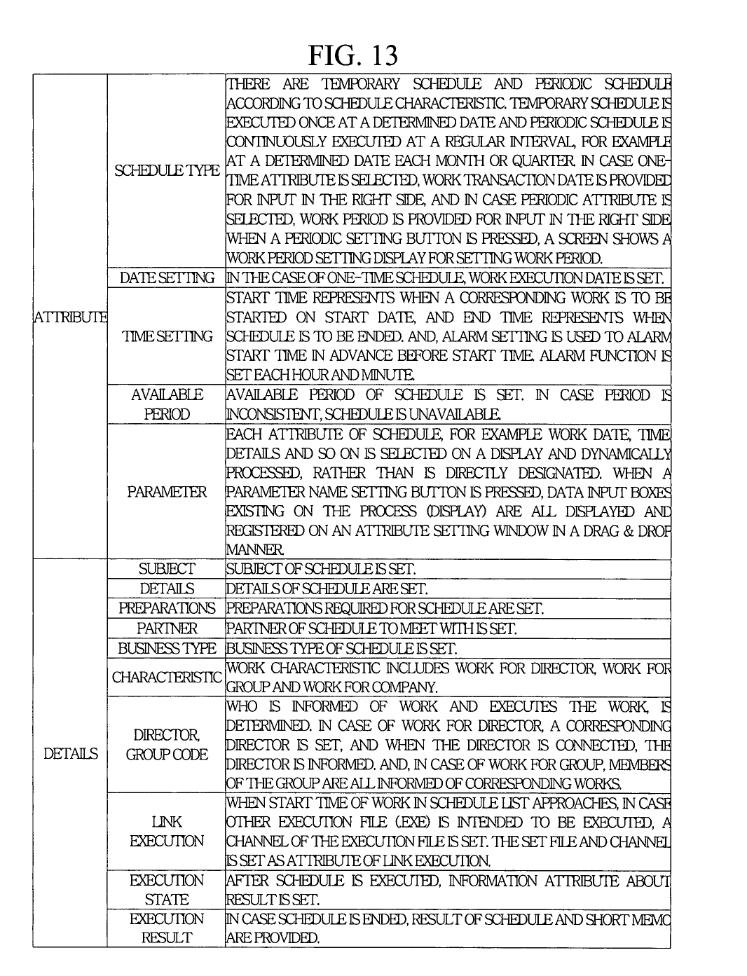

The personal schedule display is formed of a calendar using the TDB technique, and thus arranges the unit works assigned through the schedule managing engine 12 or set directly by the users as well as the unit works assigned through the workflow engine 11 in order of time, and displays the unit works on a screen in the form of a diary. And, each schedule may be searched in the form of a daily schedule display 401, a weekly schedule display 402 and a monthly schedule display 403 according to necessity of the users. When a specific item is clicked in the personal schedule display, the detailed information (including schedule type, start time, end time, subject, details, preparations, partner and so on) (See FIG. 13) of the corresponding item is displayed in a separate window 404.

FIG. 8 is a screen view illustrating a work transaction state display 501 provided by the work transaction state display unit 53 in accordance with an exemplary embodiment of the present invention.

The work transaction state display 501 receives information of the work transaction state of outstanding unit works transmitted from the work transaction state managing unit 40, and displays the unit works in the types of “completion” (completion through a normal transaction of the corresponding unit work), “pendency” (although the time limit of a corresponding unit work passes, the unit work is not transacted normally), “cancel” (a corresponding unit work is cancelled), “delay” (the time limit for transacting a corresponding unit work is extended for a specific reason) and “reservation” (transaction of a corresponding unit work is postponed indefinitely for a specific reason).

Here, after the unit works are sorted according to the work transaction state, in the work transaction state 303 of the environment setting display for selecting an array order and objects in FIG. 6, the users may directly set whether or not to display pending works having the passed time limit in a separate window.

FIG. 9 is an example view illustrating a workflow display 601 provided by the workflow display unit 54 in accordance with an exemplary embodiment of the present invention.

The workflow display 601 is a user interface display to support the users to register the frequently used workflow models, execution programs and documents, and to execute them by a simple selection.

The workflow display 601 displays a list of workflow models provided by the BPM solution, documents provided by the electronic authorization solution and execution program modules provided by business common system such as ERP in the system 1 to which the users are connected. The users select necessary workflows, execution programs and documents among them, and register the selected workflow, program or document on the workflow display 601 for a convenient use in the same manner as a bookmark function of Internet web browser.

And, when a specific workflow among the workflows registered on the workflow display 601 is selected, the users can search the detailed information 602 of the corresponding workflow. At this time, the corresponding workflow model may be executed directly by selection of the users.

FIG. 10 is a screen view illustrating an Internet contents display 701 provided by the contents display unit 55 in accordance with an exemplary embodiment of the present invention.

The Internet contents display 701 may be configured of an information service display of users' own so that the users receive updated information in real time from websites having frequent contents updating such as news or blog, using various RSS (RDF Site Summary or Rich Site Summary) service techniques available on the mark.

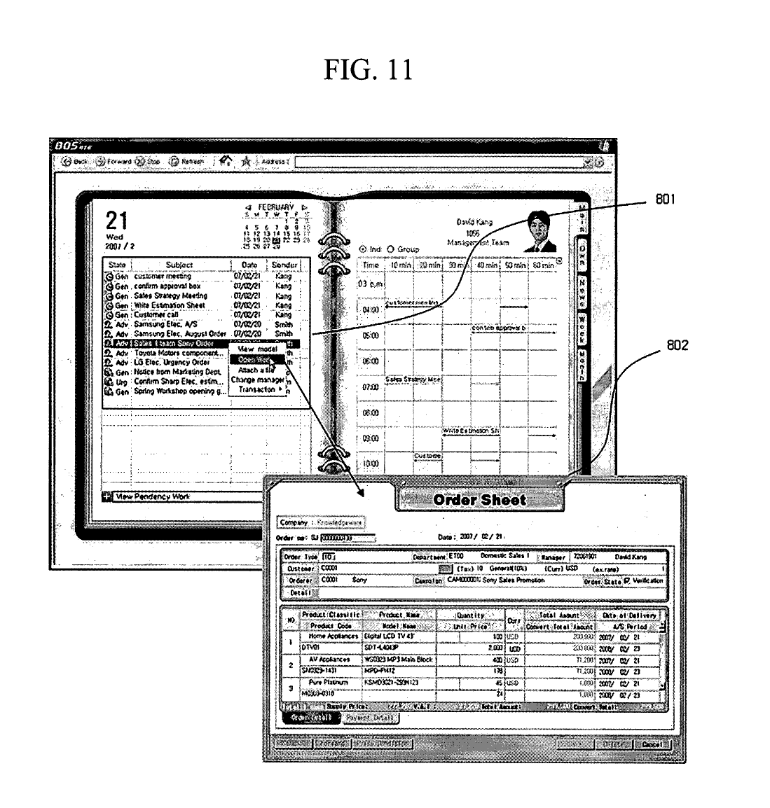

FIG. 11 is a screen view illustrating a software automatic execution display 802 provided by the business worklist display unit 51 in accordance with an exemplary embodiment of the present invention.

The software automatic execution display 802 receives information analyzed by and transmitted from the business scheduling engine 20 and sorts the information by acceptance order, importance, priority, business type and so on only from the viewpoint of the users regardless of the work occurrence source or motive. When the users select the unit work to be transacted on the worklist display 801, the application software set to transact the corresponding unit work is executed and an example of the execution display 802 is displayed.

FIG. 12 is a screen view illustrating a scheduling setting display in accordance with an exemplary embodiment of the present invention.

When a schedule managing engine component 901 provided by the present invention is generated in each module of business software connected to the system 1 for integrating operation of business software based on the TDB technique, displays 902 and 903 for setting various attribute information required to use an automatic scheduling function are executed. The detailed information of attribute information is described in the form of a table in FIG. 13.

Here, the schedule details 903 to be executed by a corresponding program module may be set by directly inputting variable names of the data input boxes existing in the corresponding program module into the management items provided by the automatic scheduling function or by connecting variable names to the management items in a Drag & Drop manner, and after the schedule details 903 are set, the corresponding program module is executed, and business execution schedule generated during execution of the corresponding program module is all automatically managed.

That is to say, after various attribute information 902 and 903 required for the automatic scheduling function is set, when data is input into the data input boxes during transacting the unit works, the scheduler engine automatically recognizes the information or variable by transaction date, transaction time, available period, subject, details, business type, preparations, partner, director and so on of the corresponding unit work, and stores the information or variable in the schedule managing database.

FIG. 13 is a view illustrating detailed attribute display of a scheduling setting display in accordance with an exemplary embodiment of the present invention.

Referring to FIG. 13, a table includes a list of attributes and the details of each attribute used in the automatic scheduling function of business software in FIG. 12. The table shows the detailed information of attributes set in the attribute information setting displays (See 902 and 903) of the automatic scheduling function.

As described above, systems and methods for integrating operation of business software managing execution of business process based on time according to the present invention includes a user interface mechanism using a TDB technique. The present invention sorts all of the unit works to be transacted in the organization based on time and automatically assigns the unit works to the users in charge by artificial intelligence function. The present invention automatically prepares and connects to execution programs or related documents required to transact the corresponding unit works. Therefore, the users can simply select their outstanding unit works and transact the corresponding unit works easily and rapidly.

In particular, an active use of the TDB technique suggested by the present invention realizes a new manner such that the unit works to be transacted are distributed to corresponding users in charge in good point of time, but not a conventional manner such that the users in charge look for their unit works to be transacted. The present invention dramatically increases a structure of transaction speed and efficiency of all of members in the organization regardless of ability or drive of the users in charge. That is, the present invention fundamentally reforms a structure of a system and a work processing method through a new technology by innovation of idea. From the viewpoint of human, the present invention forms a human-centered organization culture so that the users in charge are respected humanly and can concentrate on human function and works. And, from the viewpoint of company, the present invention provides an active and productive organization system so that the company establishes an absolute superiority in the aspect of competitiveness.

As described above, once an interface environment is established based on the TDB technique and is in practice reflected on application utility properly, the users in charge do not need to bristle up their nerve any longer lest they should forget their works at a specific point of time or do not need to waste their efforts to search for their outstanding unit works. And, the users in charge do not need to spare separate time for searching for programs or related reference documents required to transact the corresponding unit work.

Conventionally, in companies of a digital management structure using an integrating system, members are divided into smart or not, or good or poor in memory, attention and drive, and thus there are differences in results of the transacted works. However, the system having an interface of the above-mentioned innovative time-driven manner dramatically increases a structure of work transaction speed and efficiency of members in the organization, and allows the members to perform ordinary repetitive works with a result of high level regardless of their intelligence or attention.

Further, the present invention makes a system solve the problems of troublesome and obsolete functions, such as the types of the unit works to be transacted, transacting procedure and method, and preparations required to transact the unit works. Therefore, the present invention allows the users in charge to concentrate their time and passion on humanly, development-oriented, strategic, and value creative works, and provides a positive foundation for development of organization and individuals.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A system for integrating operation of business software to manage a business process by dividing a project into tasks and managing the tasks based on time, the system comprising:
an organization information managing unit for inputting and managing at least one of client information, company information, department information and user information;
a business scheduling engine for arranging a schedule for carrying out tasks of users and arranging scheduling information including work transaction information with the users in charge of the tasks;
a work transaction state managing unit for performing real-time management of work transaction states of the arranged scheduling information; and
a business portal unit for generating the scheduling information and the work transaction states in a diary interface composed of visual information and work information, providing the scheduling information and the work transaction states to the users, and providing at least one work-related additional function selected from the group including daily, weekly, and monthly personal schedule management, news search and e-mail transmission.

2. The system for integrating operation of business software of claim 1, wherein the business scheduling engine generates the scheduling information through at least one function selected from the group including:
a first function for determining a work occurrence source and motive type of the tasks by sorting the tasks into “order” for the tasks generated by the workflow engine when a time for a particular user to transact the task comes, “point of time” for the tasks occurring when a time set by the workflow engine or the schedule managing engine shows a predefined time comes, “request” for the tasks generated by the schedule managing engine or the e-mail engine in accordance with a customer's orders or user's instructions, and “awareness” for the tasks registered in the schedule managing engine in accordance with judgment or recognition of the users;
a second function for determining a work transaction speed by sorting the tasks into “regular” for the tasks that have no time limit or have to be completed by a specific due date and “urgent” for the tasks that have to be transacted instantly with the highest priority as designated by the schedule managing engine or the e-mail engine;
a third function for determining a work transaction time of the tasks by sorting the tasks into “instant” for the tasks that should be transacted as soon as possible, “time limit” for the tasks that have to be transacted by a designated time limit and “period” for the tasks that have to be transacted repetitively during a predetermined period;
a fourth function for determining a work security grade of the tasks by sorting the tasks into “public” for the tasks that can be transacted by any person and “restricted” for the tasks that have to be transacted only by a designated person; and
a fifth function for determining a work transaction range by sorting the tasks into “an individual in charge” for the tasks that are to be transacted by a user-in-charge, “an individual in duty” for the tasks that are to be transacted by a user having a specific duty, “a selective group” for the tasks that are to be transacted by any member of a selected group, and “a cooperative group” for the tasks that are to be transacted simultaneously or sequentially by members of a selected group.

3. The system for integrating operation of business software of claim 1, wherein the business scheduling engine generates the scheduling information from the tasks received from at least one engine selected from the group including:
a workflow engine for managing the tasks by a built-in workflow of a business process management (BPM) solution in the system;
a schedule managing engine for managing the tasks by schedule arrangement and management function included in each module of the business software and scheduler function set manually by the users; and
an e-mail engine for managing the tasks received through e-mails or messengers.

4. The system for integrating operation of business software of claim 3, wherein the business scheduling engine generates the scheduling information through at least one function selected from the group including:
a first function for determining a work occurrence source and motive type of the tasks by sorting the tasks into “order” for the tasks generated by the workflow engine when a time for a particular user to transact the task comes, “point of time” for the tasks occurring when a time set by the workflow engine or the schedule managing engine shows a predefined time comes, “request” for the tasks generated by the schedule managing engine or the e-mail engine in accordance with a customer's orders or user's instructions, and “awareness” for the tasks registered in the schedule managing engine in accordance with judgment or recognition of the users;
a second function for determining a work transaction speed by sorting the tasks into “regular” for the tasks that have no time limit or have to be completed by a specific due date and “urgent” for the tasks that have to be transacted instantly with the highest priority as designated by the schedule managing engine or the e-mail engine;
a third function for determining a work transaction time of the tasks by sorting the tasks into “instant” for the tasks that should be transacted as soon as possible, “time limit” for the tasks that have to be transacted by a designated time limit and “period” for the tasks that have to be transacted repetitively during a predetermined period;
a fourth function for determining a work security grade of the tasks by sorting the tasks into “public” for the tasks that can be transacted by any person and “restricted” for the tasks that have to be transacted only by a designated person; and
a fifth function for determining a work transaction range by sorting the tasks into “an individual in charge” for the tasks that are to be transacted by a user-in-charge, “an individual in duty” for the tasks that are to be transacted by a user having a specific duty, “a selective group” for the tasks that are to be transacted by any member of a selected group, and “a cooperative group” for the tasks that are to be transacted simultaneously or sequentially by members of a selected group.

5. The system for integrating operation of business software of claim 1, wherein the business portal unit provides the users with an interface display, the interface display being generated from at least one display unit selected from the group including:
a business worklist display unit for sorting the tasks received from the business scheduling engine in terms of a work acceptance order, a work transaction speed, a work transaction time, a work security grade and a work transaction range from the viewpoint of the users, regardless of work occurrence source and motive type, and providing the sorted tasks to the users;
a personal schedule display unit for arranging in order of time all schedules of the users including personal schedule information manually inputted by the users together with the scheduling information, integrating the schedules in a diary including daily, weekly and monthly types, and providing a search service of the schedules;
a work transaction state display unit for sorting information of the work transaction state of pending tasks of the users, which are received from the work transaction state managing unit, into completion, pendency, cancel, delay and reservation, and providing the sorted information;
a workflow display unit for registering detailed functions of workflow, documents and programs frequently used by the users and immediately connecting to and transacting a task selected by the users; and
a contents display unit for connecting to web sites which provide news or other contents, and real-time updating various types of external information.

6. The system for integrating operation of business software of claim 5, wherein the business worklist display unit displays the tasks designated to the users-in-charge in a diary structure, and when an item of an individual task is selected, automatically executes an application program designated to the task.

7. The system for integrating operation of business software of claim 3, wherein the schedule managing engine includes at least one function selected from the group including:
a first function for connecting a specific data input box of the business software to a scheduling management item by the users in a drag-and-drop manner;
a second function for, when a proper data is inputted to the data input box connected to the scheduling management item in the process of work transaction, recognizing task information including at least one of transaction date, transaction time, available period, title, subject, business type, preparations, partner, and director of a management item corresponding to the input data, and storing the work information in a schedule managing database; and
a third function for informing the users-in-charge of the task or automatically executing linked application programs and documents according to the task information stored in the database.

8. A method for integrating operation of business software to manage a business process by dividing a project into tasks and managing the tasks based on time, the method comprising the steps of:
identifying by a business scheduling engine at least one of a department, position and duty of users in charge of tasks;
identifying by a workflow engine of a business process management (BPM) solution the tasks automatically designated to each user;
identifying the tasks reserved to a corresponding user through a schedule managing engine that manages a schedule arrangement and management function included in each module of business software and a scheduler function through which the user sets the tasks and linked programs;
identifying demands or requests of external customers, and instructions of members of other organizations received through an e-mail engine;
determining a work occurrence source and motive type of the tasks identified in at least one of the above steps with reference to organization information of the users identified in the step of identifying by the business scheduling engine;
determining a work transaction speed of the users-in-charge according to whether the tasks are urgent or not;
determining a work transaction time required for the users-in-charge according to when the tasks should be transacted;
determining a work security grade of the users-in-charge according to a security grade of the tasks;
determining a work execution range of the users-in-charge; and
sorting a plurality of items by at least one of the work occurrence source and motive type, work transaction speed, work transaction time, work security grade, and work execution range in a diary form and transmitting the items to a business portal unit.

9. The method for integrating operation of business software of claim 8, wherein the work occurrence source and motive type of the tasks is determined by sorting the tasks into at least one category selected from the group including:
“order” for the tasks generated by the workflow engine when a time for a particular user to transact the task comes;
“point of time” for the tasks occurring when a time set by the workflow engine or the schedule managing engine shows a predefined time comes;
“request” for the tasks generated by the schedule managing engine or the e-mail engine in accordance with customer's orders or user's instructions; and
“awareness” for the tasks registered in the schedule managing engine in accordance with judgment or recognition of the users.

10. The method for integrating operation of business software of claim 8, wherein the work transaction speed is determined by sorting the tasks into at least one category selected from the group including:
“regular” for ordinary tasks which are not urgent; and
“urgent” for the tasks that have to be transacted instantly with the highest priority as designated by the schedule managing engine or the e-mail engine.

11. The method for integrating operation of business software of claim 8, wherein the work transaction time is determined by sorting the tasks into at least one category including:
“instant” for the tasks that should be transacted as soon as possible;
“time limit” for the tasks that have to be transacted by a designated time limit; and
“period” for the tasks that have to be transacted repetitively during a predetermined period.

12. The method for integrating operation of business software of claim 8, wherein the work security grade is determined by sorting the tasks into at least one category including:
“public” for the tasks that can be transacted by any person; and
“restricted” for the tasks that have to be transacted only by a designated person.

13. The method for integrating operation of business software of claim 8, wherein the work transaction range is determined by sorting the tasks into at least one category including:
“an individual in charge” for the tasks that are to be transacted by a user-in-charge;
“an individual in duty” for the tasks that are to be transacted by a user having a specific duty;
“a selective group” for the tasks that are to be transacted by any member of a selected group; and
“a cooperative group” for the tasks that are to be transacted simultaneously or sequentially by members of a selected group.
